(19) United States
(12) Patent Application Publication
(10) Pub. No.: US 2019/0317319 A1
(43) Pub. Date: Oct. 17, 2019

(54) COMMUNICATION DEVICE FOR A VEHICLE

(71) Applicant: HELLA GmbH & Co. KGaA, Lippstadt (DE)

(72) Inventors: Bernd FISCHER, Altenbeken (DE); Marc KAUP, Paderborn (DE); Alexander KLARIUS, Lippstadt (DE); Benjamin WILLEKE, Paderborn (DE); Jan-Henning WILLRODT, Hamburg (DE)

(73) Assignee: HELLA GmbH & Co. KGaA, Lippstadt (DE)

(21) Appl. No.: 16/385,742

(22) Filed: Apr. 16, 2019

(30) Foreign Application Priority Data
Apr. 16, 2018 (DE) 10 2018 108 927.9

(51) Int. Cl. G02B 27/00; G02B 17/00; H04B 10/50

(52) U.S. Cl. CPC G02B 27/0081; H04W 4/40; H04B 10/501; G02B 17/00

(57) ABSTRACT

A communication device for a vehicle which can transmit information in the form of light signals to other road users, wherein the communication device has at least one light source from which light emerges when operating the communication device, and controllable light influencer which selectively deflect or reflect or shade at least a portion of the light emanating from the at least one light source such that the at least one portion of the light exits the communication device as a light signal, or wherein the communication device comprises an array of light sources that can selectively generate light that at least partially emerges as a light signal from the communication device.

This nonprovisional application claims priority under 35 U.S.C. § 119(a) to German Patent Application No. 10 2018 108 927.9, which was filed in Germany on Apr. 16, 2018, and which is herein incorporated by reference.

### BACKGROUND OF THE INVENTION

### Field of the Invention

The present invention relates to a communication device for a vehicle and to a lighting device for a light influencer of a communication device.

### Description of the Background Art

A communication device and a lighting device of the aforementioned type are known from DE 10 2016 113 913 A1, which is incorporated herein by reference. The communication devices described therein are provided in particular for an autonomous or semi-autonomous vehicle and generates light signals which can transmit information to non-autonomous road users. The light signals may be, for example, green or red in color. In one of the embodiments described in this document, a backlit LCD panel serving as light influencer is provided from which light can emerge in different directions.

A disadvantage of conventional communication devices is, on the one hand, a relatively small, addressable solid angle of the exterior space of the vehicle and, on the other hand, comparatively poor channel separation of light signals output in different directions. Furthermore, a LCD panel is backlit with divergent light so that on an exit side of the LCD panel, imaging optics of which the entrance aperture is smaller than the diagonal of the LCD panel cannot be used.

### SUMMARY OF THE INVENTION

It is therefore an object of the present invention to provide a communication device of the type mentioned above which can effectively output light signals in different directions, wherein despite a relatively large addressable solid angle, good channel separation is made possible. Furthermore, a lighting device is to be provided which can illuminate a light influencer that on an exit side of the light influencer, optics can be used of which the entrance aperture is smaller than the diagonal of the light influencer.

In an exemplary embodiment, it is provided that the communication device has an imaging optical system through which the at least one portion of the light deflected or reflected or shaded by the light influencer or the light generated by the array of light sources at least partially moves before exiting the communication device. In particular, the optical system is designed such that the light emerging from the communication device can be imaged into a horizontal opening angle of 50° to 120°, in particular 60° to 100°, for example of at least 70°. In particular, the imaging optical system can image the plane of the light influencer or the plane of the array of light sources into the exterior space of the vehicle. Due to the imaging principle used, sharp channel separation is possible in the operating range from 1 m to 25 m.

The optical system can comprise a plurality of lenses arranged one behind the other in the propagation direction of the light, preferably at least a first outer lens, a first inner lens, a second inner lens and a second outer lens, in particular wherein the outer lenses have a larger diameter than the inner lenses. The lenses may be made of plastic, in particular of PMMA. In particular, all lenses can be made of the same material. This simplifies manufacturing.

The optical system can correspond to a Retrofocus type or the optical system can be constructed symmetrically with regard to the arrangement of the outer and inner lenses, in particular wherein the optical system corresponds to the Angulon type. By using an Angulon symmetric design principle, aberrations are at least partially avoided, thus improving separation of the addressable channels.

An aperture can be arranged between the two inner lenses, wherein the aperture is arranged in particular approximately in the plane of symmetry of the optical system. Such an aperture can further improve the separation of the addressable channels. An aperture placed in the middle of the symmetric system determines light intensity and channel sharpness. The smaller the aperture diameter, the sharper the channel images whilst the less light is imaged into the solid angle. Suitable aperture diameters may lie, for example, in a range between 0.1 mm and 10.0 mm.

The two inner lenses can be designed as converging lenses, in particular as plano-convex lenses. Furthermore, it can be provided that the two outer lenses are designed as menisci, in particular as divergent menisci, or as plano-convex lenses. Such a design of the lenses makes it possible to realize the Angulon symmetrical design principle.

On one of the lenses, for example, on the outer side of the second outer lens facing away from the other lenses, a structure can be arranged, which expands the light passing through the optical system light in the vertical direction, preferably into an opening angle of at least 90°. Since it is desirable in communication devices of the present type to have opening angles of up to 90° in the vertical plane, vertical dispersion can be caused by providing a suitable structure on an interface of the optical system which effects an expansion of the signal in the vertical direction to, for example, 90°. It is possible to influence the magnitude of the expansion with the configuration of the structure.

The light influencer can be designed as a digital micromirror device or as an LCoS or as an LC display or that the light influencer comprise a digital micromirror device or an LCoS or an LC display. The abovementioned embodiments of the light influencer make it possible to form small addressing segments which can suitably influence, in particular deflect or reflect or shade, light incident on them. For example, different columns of addressing channels of an LC display can be assigned different addressing channels for the light signals to be output. As a result, by selecting a specific column of addressing segments, a specific addressing channel into which the light signal is emitted can be selected. Alternatively, it can be provided that the light influencer comprise at least one aperture, which in particular is displaceable and/or variable in size. For example, it is also possible to provide a plurality of apertures which are displaceable relative to one another and/or arranged one behind the other.

The array of light sources can be a one-dimensional or a two-dimensional array of light sources, in particular wherein the light sources are designed as light emitting diodes (LED). In particular, the light emitting diodes can be controlled individually or by column, so that they can selectively emit light into an addressing channel.

The lighting device can comprise at least one elliptical mirror which reflects the light emerging from the at least one light source onto the light influencer. By employing an elliptical mirror, it is possible to use an optical system for decoupling the light behind the light influencer which has an entrance aperture smaller than the diagonal of the light influencer. In particular, the light rays emerging from the edge regions of the light influencer extend in the direction of the optical axis of the optical system. By means of a lighting device according to the invention, it is thus possible to achieve effective backlighting of an LC display for subsequent coupling into an optical system of a smaller diameter. Thus, the luminous flux generated by the at least one light source can be used more effectively, so that in particular the number of light sources used can be reduced.

The at least one light source can be arranged in a first of the two focal points of the at least one elliptical mirror. Further, it can be provided that the second of the two focal points of the at least one elliptical mirror is arranged in an optical system of the communication device or behind said optical system in the propagation direction of the light, through which the light emerging from the light influencer moves at least partially before exiting the communication device. As a result, the light emerging from the light influencer is effectively coupled into the optical system.

The illumination device can comprise two elliptical mirrors which together reflect the light emerging from the at least one light source onto the light influencer. In this case, it can be provided that the two elliptical mirrors are laterally offset from each other and/or inclined toward each other. By using multiple mirrors, the light influencer can be illuminated more homogeneously. It is quite possible to provide more than two mirrors.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic side view of a portion of a first embodiment of a communication device according to the invention;

FIG. 2 is a schematic diagram to illustrate the backlighting of the light influencer;

FIG. 3 is a schematic side view of an embodiment of a lighting device according to the invention;

FIG. 4 is a schematic side view of a second embodiment of a communication device according to the invention with an embodiment of a lighting device according to the invention;

FIG. 5 is a perspective view of an elliptical mirror and a light source of a lighting device according to the invention arranged upstream thereof;

FIG. 6 is a perspective view of a third embodiment of a communication device according to the invention with a lighting device according to the invention, which has two elliptical mirrors;

FIG. 7 is a portion of the luminous intensity distribution of the light emitted from a communication device according to the invention when using six channels;

FIG. 8 is a portion of the luminous intensity distribution of the light emitted from a communication device according to the invention provided with a structure for vertical expansion when using six channels;

FIG. 9 illustrates the luminous intensity distribution of the light emitted from a communication device when all channels are used and the light influencer are illuminated, with an embodiment of a lighting device according to the invention having two elliptical mirrors;

FIG. 10 illustrates the luminous intensity distribution of the light emitted from a communication device when using a central channel and illuminating the light influencer, with an embodiment of a lighting device according to the invention having two elliptical mirrors; and

FIG. 11 illustrates the luminous intensity distribution of the light emitted from a communication device when using a peripheral channel and illuminating the light influencer, with an embodiment of a lighting device according to the invention having two elliptical mirrors.

### DETAILED DESCRIPTION

In the depicted embodiments of communication devices and vehicles equipped therewith, a new type of communication between man and machine is to be made possible when integrating autonomous vehicles into non-autonomous traffic events. In particular, a complete environmental model that is available to a vehicle can be provided, which includes information relevant to the driving task in regards of road users and their positions as well as their intentions.

For this purpose, sensor-data fusion of any sensor, such as radars, lidars, infrared cameras, visible light cameras or laser scanners as well as stored maps can be used. An arithmetic unit, which is fed with this environment data, can determine in which beam angles which road user is located and whether or not communication is necessary to understand and better respond to an imminent traffic situation. Necessary beam angles for light signals with corresponding coloration are then conveyed via a vehicle-internal network and transmitted to the communication device or to a plurality of communication devices. The communication devices make it possible to transmit different light signals in different directions, so that only road users who are located in the corresponding solid angles can perceive the light signal. It is also possible to aim for several solid angles in parallel with different information. Thus, depending on the viewing angle, the communication device displays different colors. Green can signal that the autonomous vehicle has detected the respective road user. Red may mean that the road user has been detected but has to give priority to the autonomous vehicle. If a person who has to get into an autonomous car sharing vehicle is to be alerted to the correct vehicle which he wishes to get into, the communication device makes it possible to specifically address said person with a light signal. It can be provided, in addition to car sharing functions, to also integrate welcome or goodbye functions.

In this case, a communication device can be placed anywhere on the vehicle. One possibility is, for example, placement at the A, B or C or D pillar. However, dividing the solid angles to be operated into two or more communication devices, so that, for example, in each case an area of 70° can be covered, is also conceivable.

It is also possible to arrange a communication device at the front of the vehicle, for example in the upper region of the windshield. Alternatively, a communication device could also be arranged in the upper area of the rear of the vehicle. Further placement options are placing it in the headlight or in the wheel well, which is particularly advantageous at night. At night, a pedestrian no longer necessarily looks at the driver, because he is usually in the dark.

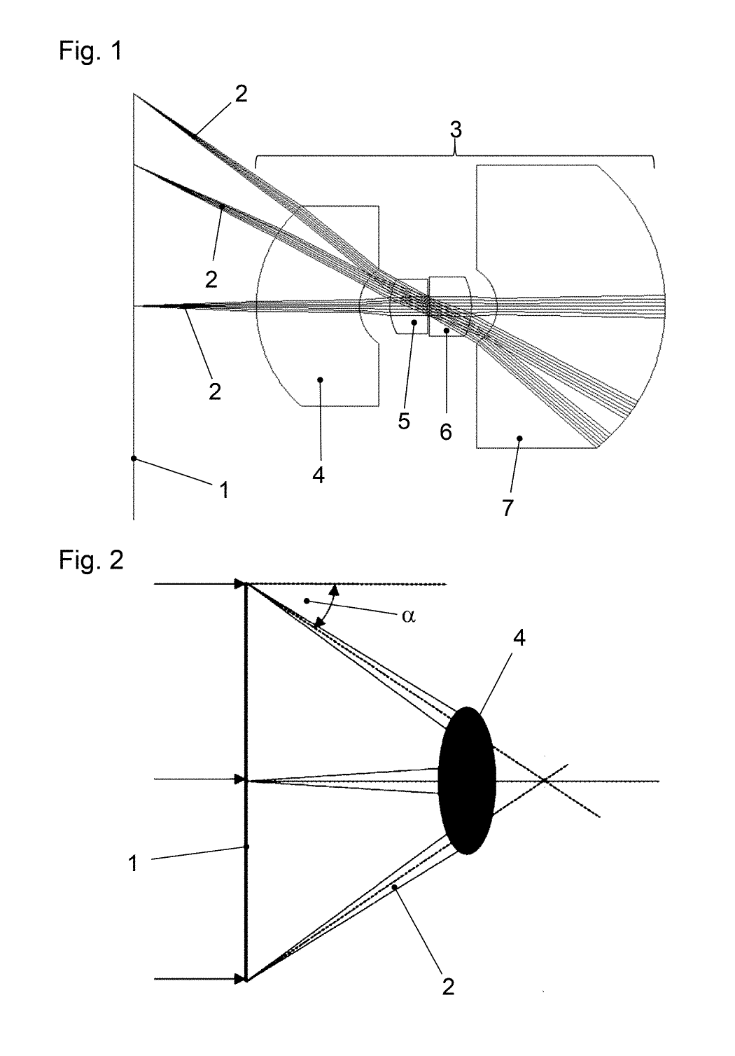

The embodiment of a communication device according to the invention shown in FIG. 1 comprises at least one light source. As a light source, for example, a light emitting diode (LED) or a laser diode can be used. The communication device further comprises light influencer 1, which are embodied, for example, as a digital micromirror device or as an LCoS or as an LC display or comprise a digital micromirror device or an LCoS or an LC display. The light influencer 1 can address a certain solid angle, so that light is radiated into this solid angle.

For example, different columns of addressing segments of an LC display can be assigned different addressing channels for the light signals to be output. As a result, by selecting a specific column of addressing segments, a specific addressing channel can be selected into which the light signal is emitted.

The illumination or backlighting of the light influencer 1 with the light 2 emerging from the at least one light source may already contain the color which the communication device is to emit. The light influencer 1 then open up the channels, which are deflected in the corresponding direction by the optical system 3 that will be described in more detail below. Alternatively, the light influencer 1 can be illuminated or backlit with white light and the correct color is obtained by using color filters.

Instead of combining a light source and light influencer, it is also possible to provide a one-dimensional or a two-dimensional array of light sources. The light sources can be designed, in particular, as light emitting diodes (LED) that can be controlled individually or in columns, which can thus also selectively emit light into a channel, which is then deflected in the appropriate direction by the optical system 3 described in more detail below.

In the embodiment shown, the optical system 3 arranged in the propagation direction of the light 2 behind the light influencer 1 has four lenses 4, 5, 6, 7, through which the light 2 passes in succession. From left to right in FIG. 1, a first outer lens 4, a first inner lens 5, a second inner lens 6 and a second outer lens 7 are provided, wherein the outer lenses 4, 7 have a larger diameter than the inner lenses 5, 6. In this case, the optical system 3 is constructed symmetrically with regard to the arrangement of the outer and inner lenses 4, 5, 6, 7. The optical system 3 corresponds in particular to the Angulon symmetrical construction principle.

In the embodiment shown in FIG. 1, the two outer lenses 4, 7 are formed as menisci, in particular as divergent menisci. It is quite possible, instead of menisci, to provide other shapes for the outer lenses 4, 7, such as the plano-convex shapes of the outer lenses 4, 7 indicated in FIG. 4. The two inner lenses 5, 6 are converging lenses, in particular designed as plano-convex lenses.

Between the two inner lenses 5, 6, an aperture is provided. An aperture placed in the middle of the symmetric system determines the light intensity and channel sharpness. The aperture sizes may be, for example, in a range of 0.1 mm to 10.0 mm. Sharper channel images can be realized with a smaller aperture diameter than with larger aperture diameters.

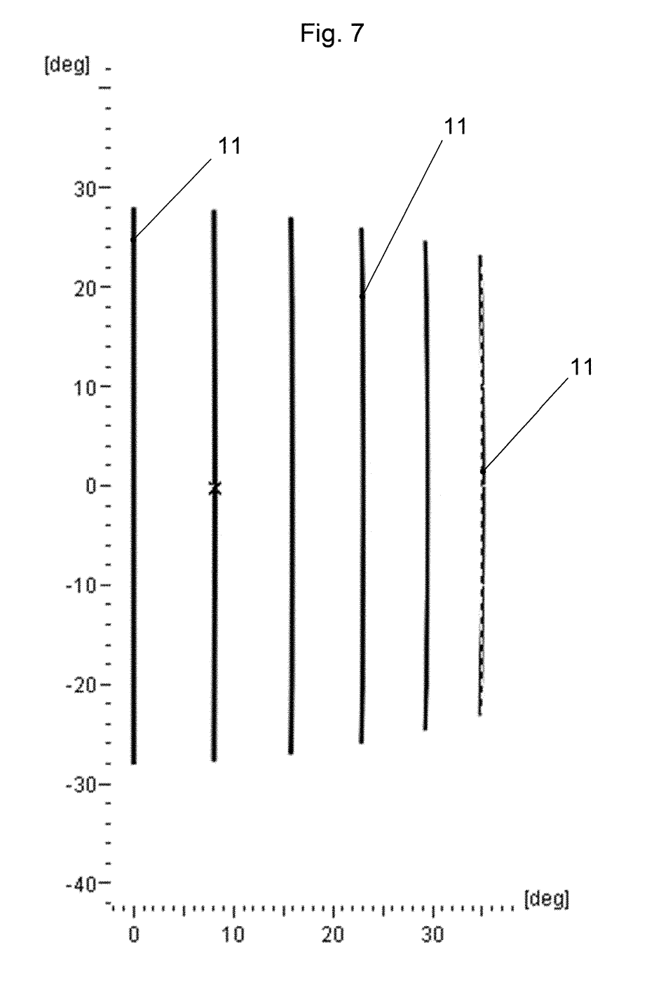

FIG. 7 depicts two quadrants of the luminous intensity distribution of the light emitted by the communication device shown in FIG. 1 when six channels are used. The figure shows that the channels in each case generate a sharp and homogeneous light signal 11 in the horizontal direction at a field angle of 35°, and in the vertical direction at an angle range of −25° to 25°. By taking into account the remaining quadrants of the luminous intensity distribution, an opening angle of approximately 70° in total can thus be addressed in the horizontal direction.

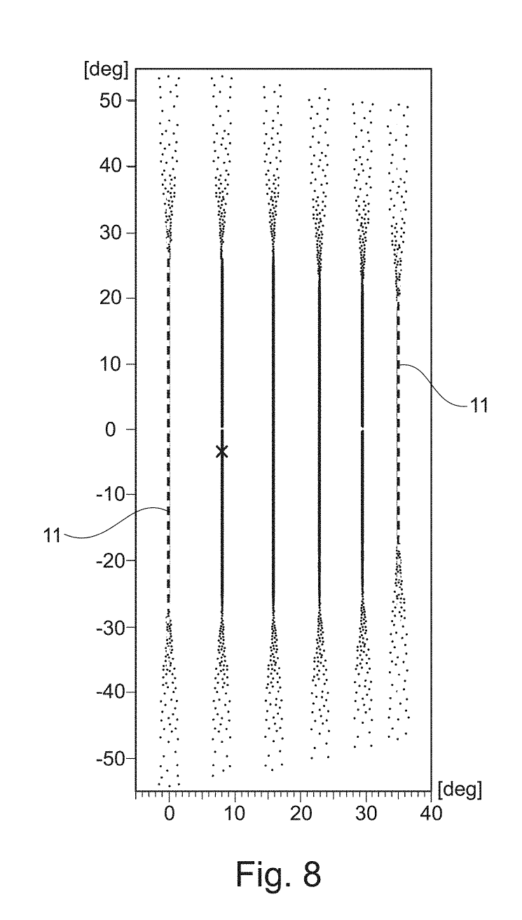

FIG. 8 shows two quadrants of a luminous intensity distribution of the light emitted when six channels of a communication device are used, wherein this communication device is different from the one depicted in FIG. 1. The difference is, in particular, that a structure is arranged on the exit surface of the second outer lens 7, which, for example, may include a plurality of thickenings arranged one above the other and extending in the horizontal direction. The structure serves to somewhat widen the light emerging from the second outer lens 7 in the vertical direction by scattering. This can be seen in FIG. 8, in which the emitted light signals 11 have an opening angle of approximately 90° in the vertical direction.

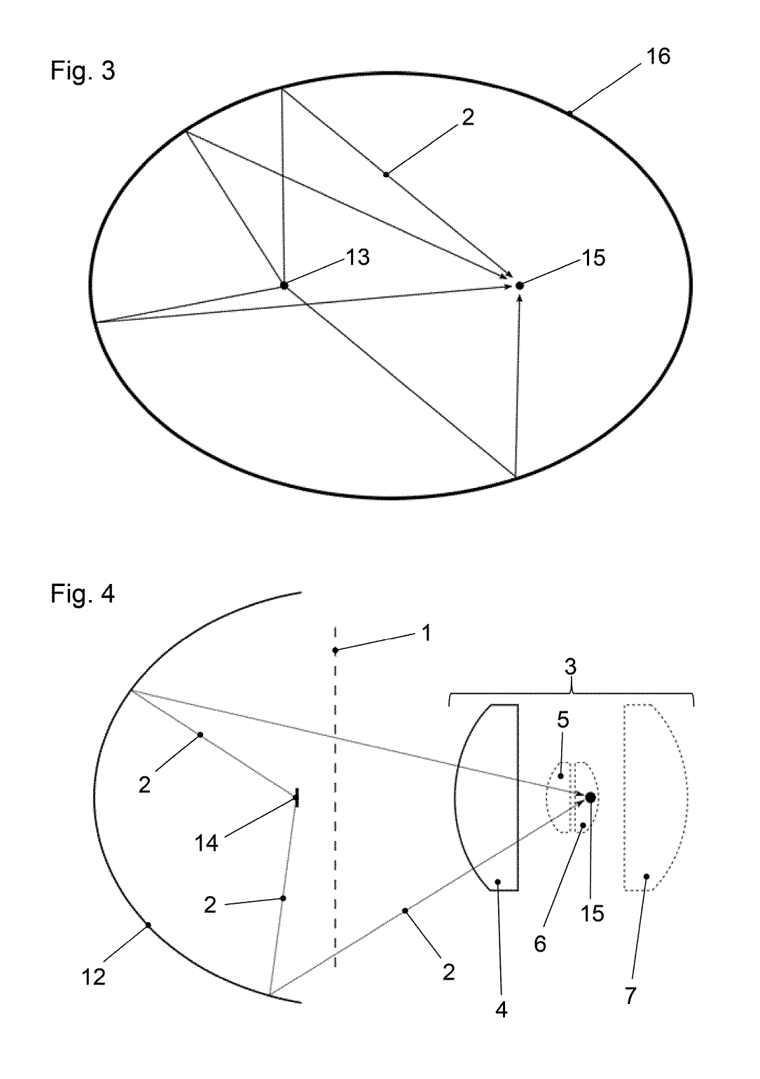

FIG. 2 illustrates a problem that results from the fact that the light influencer 1 have a significantly larger diameter than the first outer lens 4 of the optical system 3, which serves as the entrance aperture of the optical system 3. So that a large part of the light 2 used for the illumination or backlighting of the light influencer 1 does not pass by the optical system 3 and therefore remain unused, the light 2 emanating from the edge regions of the light influencer 1 should form at least an angle α with the normal on the light influencer 1 (see FIG. 2).

This can be achieved by the embodiment of an inventive lighting device shown schematically in FIG. 4. This embodiment comprises an elliptical mirror 12, in whose first focal point 13 the at least one light source 14 of the communication device is arranged. It is thereby achieved that the light 2 emanating from the light source 14 propagates in the direction of the second focal point 15 of the ellipse 16 of the elliptical mirror 12 (see also the schematic diagram in FIG. 3).

It is apparent from FIG. 4, that light 2 (see the lower edge of the light influencer 1 in FIG. 4) having passed through edge regions of the light influencer 1 forms such an angle with the normal on the light influencer 1 that it enters the first outer lens 4 and thus can escape through the optical system 3 from the communication device. In this case, the second focal point 15 of the ellipse 16 of the elliptical mirror 12 lies approximately in the region of the second inner lens 6.

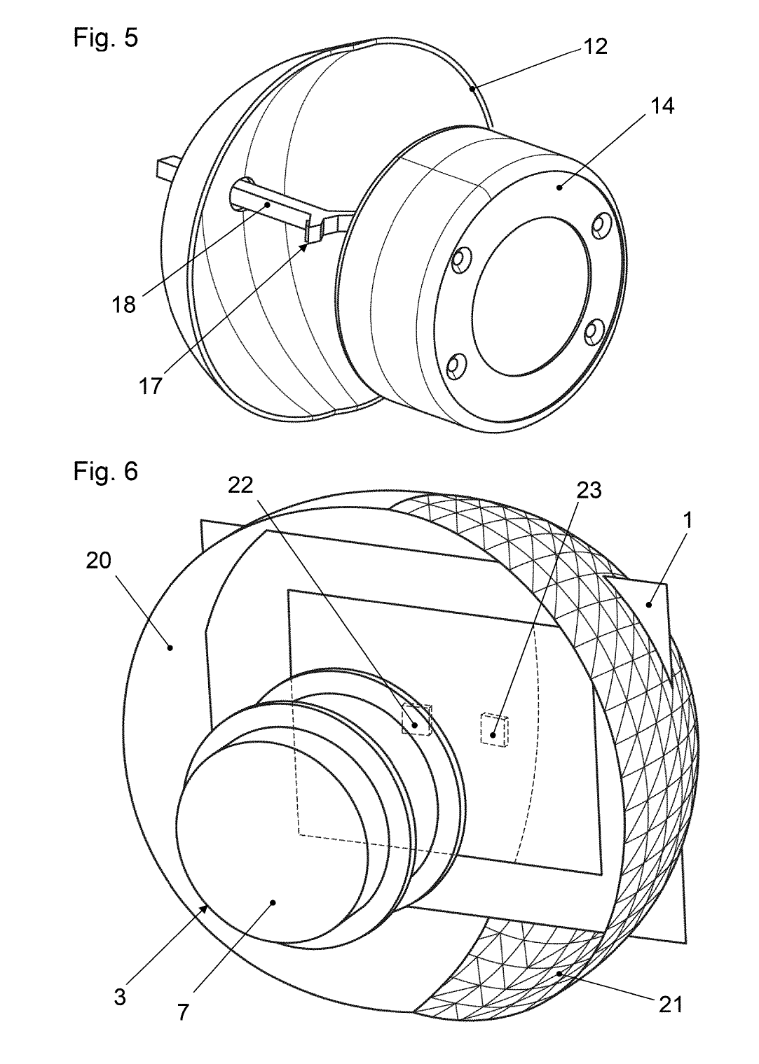

The at least one light source 14 can be held in front of the elliptical mirror 12 by a holder 17 schematically indicated in FIG. 5 in such a way that the light exit surface of the light source 14 is located in the first focal point of the elliptical mirror 12. In this case, a portion 18 of the holder 17 may protrude through the mirror 12.

A luminous intensity distribution of the light emitted from a communication device when using all channels and when illuminating the light influencer 1 using an embodiment of a lighting device according to the invention, which substantially corresponds to FIG. 4, is comparatively inhomogeneous and has a central maximum.

The luminous intensity distribution can be homogenized by using two or more than two elliptical mirrors instead of one elliptical mirror 12. FIG. 6 shows a communication device with a lighting device in which two elliptical mirrors 20, 21 are provided. The elliptical mirrors 20, 21 are laterally offset from each other and inclined toward each other. In FIG. 6, in addition to the light influencer 1 and the optical system 3, light sources 22, 23 are also indicated which can be disposed in the first focal points of the two elliptical mirrors 20, 21.

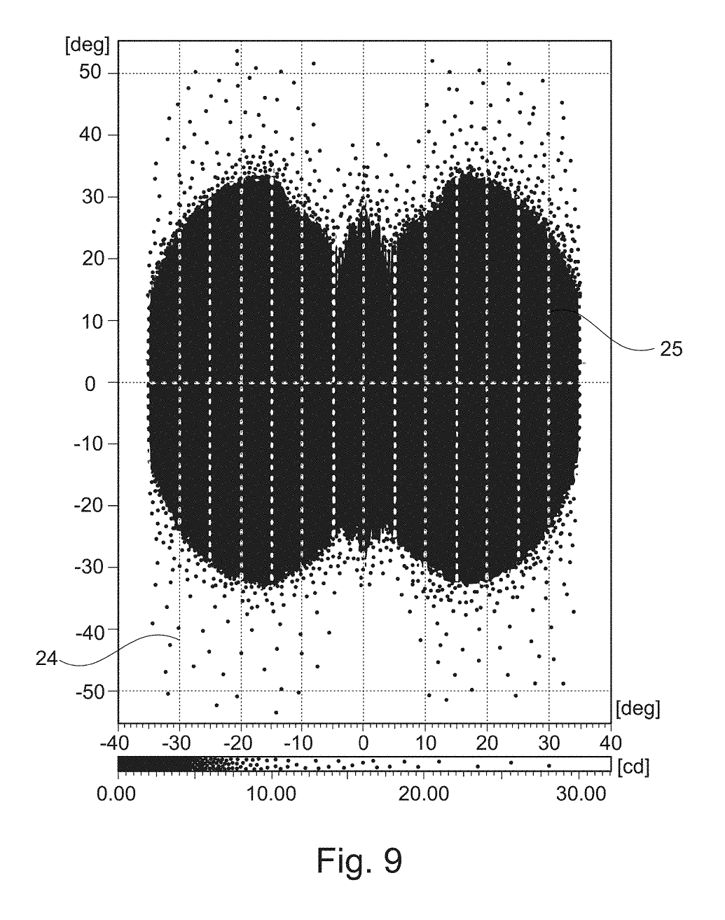

FIG. 9 shows the luminous intensity distribution of the light emitted from a communication device when all channels are used and the light influencer 1 are illuminated, using an embodiment of an illumination device according to the invention which substantially corresponds to FIG. 6. It can be seen that in this embodiment the luminous intensity distribution is substantially more homogeneous and has two off-center maxima 24, 25.

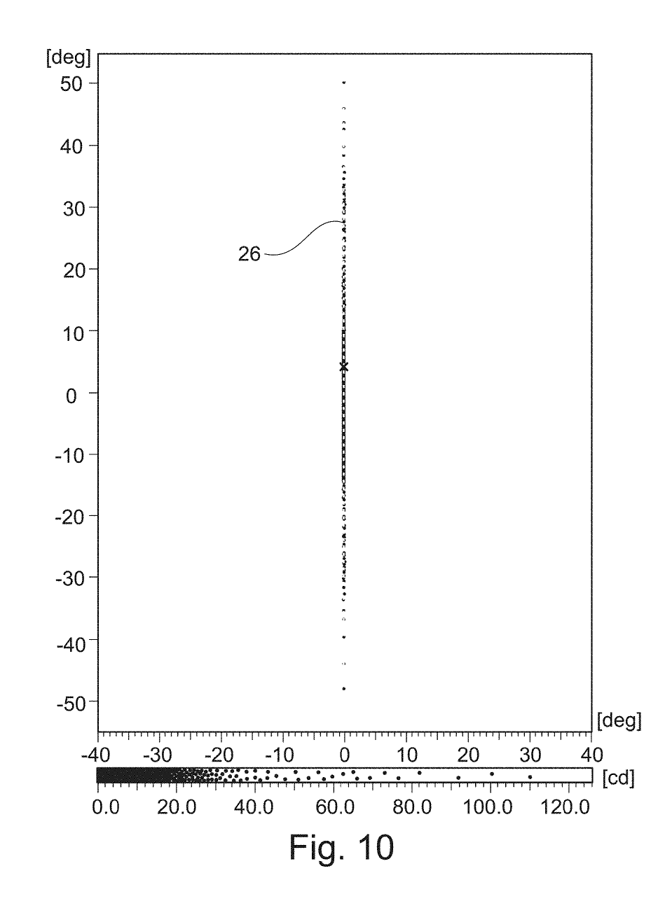

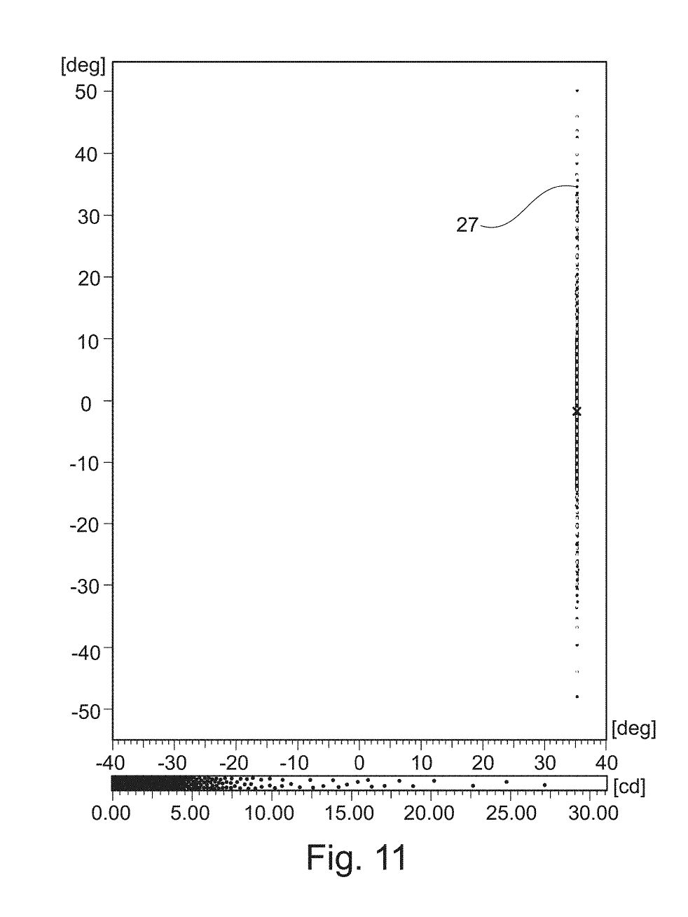

FIG. 10 and FIG. 11 also illustrate that the embodiment with two elliptical mirrors 20, 21 leads to relatively sharp, marginally broadened light signals 26, 27. Channel stability is better in the dual mirror embodiment than in the single mirror embodiment.

By increasing the number of elliptical mirrors beyond two, the homogeneity of the illumination or the backlighting can be further increased and thus channel stability can be further improved.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A communication device for a vehicle, which is able to transmit information to other road users in the form of light signals, the communication device comprising:
at least one light source from which light emerges during operation of the communication device or an array of light sources adapted to selectively generate light which at least partially emerge from the communication device in the form of a light signal; and
a controllable light influencer that is adapted to selectively deflect or reflect or shade at least a portion of the light emerging from the at least one light source such that the at least one portion of the light emerges as a light signal from the communication device; and
an imaging optical system through which the at least one portion of the light deflected or reflected or shaded by the light influencer or the light generated by the array of light sources at least partially moves before exiting the communication device.

2. The communication device according to claim 1, wherein the optical system is configured such that the light emerging from the communication device is displayed at a horizontal opening angle of 50° to 120°, 60° to 100°, or at least 70°.

3. The communication device according to claim 1, wherein the optical system has a plurality of successively arranged lenses in a propagation direction of the light or has at least one first outer lens, a first inner lens, a second inner lens and a second outer lens, and wherein the first or second outer lenses have a larger diameter than the first or second inner lenses.

4. The communication device according to claim 1, wherein the optical system corresponds to a Retrofocus type or wherein the optical system is constructed symmetrically with respect to an arrangement of the outer and inner lenses, or wherein the optical system is of an Angulon type.

5. The communication device according to claim 3, further comprising an aperture arranged between the first and second inner lenses, wherein the aperture is arranged approximately in a symmetry plane of the optical system.

6. The communication device according to claim 3, wherein the first and second inner lenses are converging lenses or plano-convex lenses, or wherein the first and second outer lenses are designed as menisci, as divergent menisci, or as plano-convex lenses.

7. The communication device according to claim 3, wherein on one of the lenses or on an outer side of the second outer lens facing away from the other lenses a structure is arranged that expands the light passing through the optical system in a vertical direction or an opening angle of at least 90°.

8. The communication device according to claim 1, wherein the light influencer is a digital micromirror device or as an LCoS or as an LC display, or wherein the light influencer comprise a digital micromirror device or an LCoS or an LC display.

9. The communication device according to claim 1, wherein the array of light sources is a one-dimensional or a two-dimensional array of light sources, or wherein the light sources are light emitting diodes.

10. A lighting device for a light influencer of a communication device according to claim 1, the lighting device comprising:
at least one light source; and
at least one elliptical mirror that reflects the light emerging from the at least one light source onto the light influence.

11. The lighting device according to claim 10, wherein the at least one light source is arranged in a first of two focal points of the at least one elliptical mirror.

12. The lighting device according to claim 10, wherein the second of the two focal points of the at least one elliptical mirror is arranged in or in the propagation direction of the light behind an optical system of the communication device, through which the light emerging from the light influencer at least partially moves before exiting the communication device.

13. The lighting device according to claim 10, wherein the lighting device comprises two elliptical mirrors that together reflect the light emerging from the at least one light source onto the light influencer.

14. The lighting device according to claim 13, wherein the two elliptical mirrors are laterally offset from each other and/or inclined toward each other.

15. The communication device according to claim 1, wherein the communication device is a communication device of a vehicle.
